(19) United States
(12) Patent Application Publication
(10) Pub. No.: US 2018/0210471 A1
(43) Pub. Date: Jul. 26, 2018

(54) INTELLIGENT PIPE CONNECTOR, SYSTEM AND METHOD

(71) Applicant: Mohammed Zulfiquar, Birmingham (GB)

(72) Inventor: Mohammed Zulfiquar, Birmingham (GB)

(21) Appl. No.: 15/415,895

(22) Filed: Jan. 26, 2017

(51) Int. Cl. G05D 7/06; G05B 15/02

(52) U.S. Cl. CPC G05D 7/0688; G05B 15/02

(57) ABSTRACT

An intelligent pipeline system for supplying fluid includes a pipeline having a plurality of pipes coupled to one another by a plurality of intelligent pipe connectors. Each of the intelligent pipe connector connects at least one end portions of two subsequent pipes of the plurality of pipes to form the pipeline. The plurality of intelligent pipe connectors monitors differences of at least one of the data of the plurality of data between each of the two subsequent intelligent pipe connectors of the plurality of intelligent pipe connector along the pipeline. Furthermore, the system may include a central control unit to receives the plurality of data and act accordingly on the real time basis based on the differences of the at least one data of the plurality of data along the pipeline.

### CROSS REFERENCE TO RELATED APPLICATION

This application is a continuation in part (“CIP”) patent application and claims the priority date(s) of U.S. patent application Ser. No. 14/546,328 filed on or about Nov. 18, 2014 and U.S. patent application Ser. No. 14/546,299 filed on or about Nov. 18, 2014. The '328 application is a regular of U.S. provisional patent application 61/905,393 (filed on or about Nov. 18, 2013). The '299 application is a regular of U.S. provisional patent application 61/905,381 (filed on or about Nov. 18, 2013). The present application claims the priority dates of the patent applications listed above and those listed in the concurrently filed Application Disclosure Statement or ADS.

### FIELD OF ENDEAVOR

The present disclosure relates to the field of pipeline monitoring and protection, and, more particularly, a pipeline leakage protection system with an inbuilt disaster recovery.

### BRIEF DESCRIPTION OF THE RELATED ART

Pipelines are most significant mode for transporting fluid fuels, such as Oil and Gas; equally significant is its monitoring and protection from various unwanted issues, such as leakage, theft etc. Such unwanted issues directly or indirectly affect the oil and gas communities and environment throughout the world. In Nigeria alone, for instance, oil pipeline theft reduces output by approximately 15% per annum representing a loss of $7 billion plus. Due to the sensitivity of these thefts, the true figure may be even greater than the considerable 16,083 recorded pipeline breaks in the last decade. Similarly, leakage in the pipelines is great threat to environment, which badly affects surrounding and living beings around the leakage area.

Various efforts in past 50 years have been made from time to time to overcome with such unwanted issues on selected region basis across the pipelines path, using methods or tools, such as conducting statistical analysis, or doing airborne reconnaissance, or regular pressure monitoring of the pipelines, Computational Pipeline Monitoring (CPM) software, etc. Further, such methods and tools are limiting in respect of what factor are required to be monitored in which region of the pipeline, for which an exhaustive separate analysis are made on the pipes before its installation. For example, if the pipe in a pipeline is required to be installed in pressure sensitive areas, such as in deep sea or ocean or above the hills, then pipe is required to be tested various pressure tests before installation. After installation, such pipes are installed with such CPM software that are capable of regularly monitoring pressure. In such event, other parameter relating to pipeline in those area may be ignore, which risks the pipeline failure due other factor that may not be assumed or ignored. It means that the presently available pipelines are always lacks integrity in terms of risk due to various unknown factor that may also result to pipeline leakage, failure or theft at any portion of the entire pipeline.

Furthermore, wherever, such method or tools are installed along the pipelines are generally utilized as data collection tools or method which sends all the collected data to a specific data centers for its processing, which increase the load on the data center and delays the information relevant to the pipeline.

In all that regard to above problems very little innovation has taken place in the pipeline integrity, where the entire pipeline is prevented or monitored on the regular basis and that also reduces such delays in generating data and reducing load on the central servers. This is largely due to the fact pipelines were new and risks were determined to be low. In addition, the values of oil or gas were relatively low, at around $10 per barrel, which made pipeline theft virtually non-existent. The world today now has a far different landscape as the price of oil and gas per barrel hovers around $100. Because of the changes, the oil and gas industry is desperate to address the massive financial losses and environmental degradation that are associated with both pipeline theft and leakage. In addition, the pipeline industry is grappling with mounting regulatory pressures.

Even if by all the measures irrespective of complexity of the any such available tools or method may at one time consider to be satisfactory in arranging and sending any relevant information in an event of leakage, it fails to however, stop such leakage instantly. Whatever time that is required to stop the leakage of the fluid results wastage of fluid and pollution to the environment.

Unfortunately the lack of innovation and effective investment in research and development to address these issues has meant the solutions 20 years ago are no different to the ones offered today by servicing companies. Accordingly, there exists a need innovation in relation to the pipeline integrity, where the entire pipeline is prevented or monitored on the regular basis and that also reduces such delays in generating data and reducing load on the central servers; and at the same time may be capable of avoiding such leakage of the fluids to environment.

### SUMMARY

The present disclosure describes an integrated pipeline monitoring and protection system in the pipeline utilized for carrying fluids such as oil and gas. This will be presented in the following simplified summary to provide a basic understanding of one or more aspects of the disclosure that are intended to overcome the discussed drawbacks, but to include all advantages thereof, along with providing some additional advantages. This summary is not an extensive overview of the disclosure. It is intended to neither identify key or critical elements of the disclosure, nor to delineate the scope of the present disclosure. Rather, the sole purpose of this summary is to present some concepts of the disclosure, its aspects and advantages in a simplified form as a prelude to the more detailed description that is presented hereinafter.

An object of the present disclosure is to describe a pipeline leakage protection vault system for protection of leakage in a pipeline, which will offer real time monitoring and protection of the entire pipeline regarding leakage, theft or predict even future leakage and enables to take preventive measures to avoid such leakage or theft; and in event of any leakage capable of withholding the fluid (oil) therewithin. Another object of the present disclosure is to provide such module that may installed along the entire pipeline to enable pipeline integrity in terms of protection of the entire pipeline as against the available prior-art technologies which are largely based on the protection or presentation of specific regions of the pipeline. Another object of the present disclosure is to provide such a module that is capable of monitoring, if required, all the relevant parameters of the pipelines in a cost effective manner as against the available prior-art technologies where specific tools or method are incorporated on the pipeline which are only required in that region of the pipeline because of huge costing involved in installing all the tools and method at each locations of the pipelines. Another object of the present disclosure is to provide such module or system that are capable of generating real time data of the pipeline and at the same time reduce the processing load on a central server. Furthermore, one of the most important object of the present disclosure is to preclude oil/gas leakage in any case to avoid pollution and wastage of thereof. Various other objects and features of the present disclosure will be apparent from the following detailed description and claims.

The above noted and other objects, in one aspect, may be achieved by a pipeline leakage protection vault system (hereinafter may also referred to as ‘system’) of the present disclosure. A pipeline leakage protection vault system includes a plurality of leakage protection vault modules and a central control unit adapted to be communicably configured to the plurality of modules. The plurality of leakage protection vault modules adapted to be circumferentially disposed to portions of a pipeline and capable of communicably configured to each other to generate a plurality of real time data relating to the pipeline. Each module includes a retrofittable configuration adapted to include at least two sub-modules coupled to be snugly disposed circumferentially around the portion of the pipeline. Each sub-module includes at least one protective casing, spacer rings and a vault door. The protective casing is adapted to compliment the portion of the pipeline to be fitted thereover to protect the fluid in event of leakage of the pipeline. Further, the spacer rings are adapted to be disposed circumferentially over the protective casing in spaced relationship from each other. The spacer rings includes a plurality of components adapted to monitor a plurality of parameters associated with the pipeline and capable of generating the plurality of real time data related to the pipeline. Furthermore, the vault door disposed over the top protective casing and rest over the spacer rings covering the sub-module. The vault door adapted to be communicably configured to the plurality of components to receive signals in event of detection in leakage of the pipeline, and be actuated to withhold the fluid therewithin preventing leakage of the fluid to environment.

The leakage protection vault modules (herein after may be also referred to as “vault module”) may include, but not limiting to, its ability to contain the fluid oil therewithin rather than into the environment, thereby protecting environmental catastrophes and clients' most valuable asset, which is oil. In simplified the vault module makes the present system an inbuilt disaster recovery system. The central control unit which is adapted to be communicably configured to the plurality of modules receives such real time data related to the pipeline and generate a plurality of related information of the pipeline. In one further preferred embodiment, at least one GPS (Global Positioning System) sensor/nanosensor are disposed on the spacer ring to coordinated with a GPS satellite to enable the communication between the plurality of modules and the central control unit. Such GPS sensor/nanosensor may be one of the plurality of components enabled in the module.

In one embodiment, at least one of the plurality of components disposed on the spacer rings is at least one oil leakage sensor/nanosensor to monitor/sense the parameters related to leakage or security breach in the pipeline and subsequently communicate the real time data of leakage or security breach in the pipeline with the central control unit.

In one embodiment, at least one of the plurality of components disposed on the spacer rings is an alarming cloak jet and sensors/nanosensors arrangement. The arrangement includes sensors/nanosensors and an alarming clock jet. The sensors/nanosensors are arranged across the spacer rings to sense the parameters related to leakage or security breach in the pipeline and generate the real time data of leakage or security breach of the pipeline. Further, the alarming clock jet is disposed on the spacer ring and configured to release dense smoke alarming signal coupled with at least one of high pitch audio alarm and visual lights signal, directly upon being sensed by the sensors/nanosensors or upon the instruction of the central control unit in event of the leakage or security breach of the pipeline based on the real time data of leakage or security breach of the pipeline sent to the central control unit by the sensors/nanosensors.

In one embodiment, at least one of the plurality of components disposed on the spacer rings is at least one temperature sensor/nanosensor to detect the real time data relating to thermal parameters of with the pipelines to communicate to the central control unit.

In one embodiment, at least one of the plurality of components disposed on the spacer rings is at least one visual recording device to record video information of the various parameter related to the pipeline about the leakage or security breach and communicate the real time date of the pipeline to the central control unit.

In one embodiment, the system further includes a shutdown-valve configured in the module to be actuated via at least one of the set of sensors/nanosensors or at least one of the components in event of the leakage of the pipeline.

As mentioned above about the protective casing, in one embodiment, the protective casing may be single layered structure. In another embodiment, the protective casing may be multilayered structure with or without an additional layer that is capable of facilitating the process of parameter collection, processing and sending it to central control unit, along by itself or in-combination with the plurality of components configured on the spacer ring. Such additional layer may be capable of communicating with various modules, various components that are configured on the spacer ring and to the central control system, individually, or in in-combination with the various components that are configured on the spacer ring.

In a most preferred embodiment, the protective casing includes top and bottom protective casings and an addition layer of at least one flexible composite layer which incorporates thereon at least one layer of electronic circuitry and a plurality of nanosensors. The layer of electronic circuitry is embedded on the flexible composite layer, and includes a plurality of microchips embedded on each layer thereof. Further, the nanosensors are also embedded on the flexible composite layer in coupling relationship with the electronic circuitry and microchips. A combinational arrangement of the nanosensor, the electronic circuitry and microchips on the flexible composite layer are capable to monitor and process a plurality of parameters, associated with the pipeline to generate at least one of the plurality of real time data relating to the pipeline, such as pipeline leakage, predict stress, strain, fatigue measurement, corrosion and erosion, future leakage or failure, and detect any attempt to theft or tempering in the pipeline. Further, a dielectric layer may be coated over the flexible composite layer to protect the flexible composite layer and the combinational arrangement of the nanosensor, the electronic circuitry and microchips.

The top and bottom protective casings are adapted to encase the flexible composite layer from the top and bottom side of the flexible composite layer. Among these layers of the protective casing, the top layer may further change to suit specific requirements or application, for example, the top casing may be of a single layered structure of multiple layered structures.

Further, in additional embodiment, the central control unit which is adapted to communicably configure with the plurality of modules receives such real time data related to the pipeline and generate a plurality of related information of the pipeline from the combinational arrangement of the nanosensor, the electronic circuitry and microchips, at least one of the nanosensor, where at least one nanosensor is a GPS (Global Positioning System) nanosensor, which with association of the electronic circuitry and the microchips, is adapted to coordinated with the GPS satellite to enable the communication between the plurality of modules and the central control unit, individually or in-combination with the GPS (Global Positioning System) sensor/nanosensor that is disposed on the spacer ring.

Further, in another additional embodiment, there may be at least one failsafe mechanism configured on at least one of the flexible composite layer or the spacer ring. The fail safe mechanism may include a plurality of photonics boxes, which independently or in coordination with the combinational arrangement of the nanosensor, the electronic circuitry and microchips, are actuated via voltage to generate information signals in event of leakage, security breach, breakage and monitor of the pipeline on real time basis.

In one further preferred embodiment, the system may further include a photovoltaic arrangement configured to at least the flexible composite layer or the spacer ring, which in coordination with the combinational arrangement of the nanosensor, the electronic circuitry and microchips to generate required voltage for the operation of the photonics boxes and the flexible composite layer.

In one further preferred embodiment, the system may further include a provision of alarming signal in event of any default. Specifically, in the combinational arrangement of the nanosensor, the electronic circuitry and microchips, at least one microchip may be an alarming microchip with an integrated software, which in combination of the nanosensor and the electronic circuitry is adapted to generate alarming signal, the signal being audio, smoke, visual lights, in event of leakage or security breach of the pipeline.

In one aspect an intelligent pipeline system for supplying fluid from one part of location to another part of location is provided. The intelligent pipeline system includes a plurality of pipes coupled to one another to form the pipeline for supplying the fluid. The intelligent pipeline system may further include a plurality of intelligent pipe connectors to monitor a plurality of data along the pipeline. Each of the intelligent pipe connector of the plurality of intelligent pipe connectors connects at least one end portions of two subsequent pipes of the plurality of pipes to form the pipeline. The plurality of intelligent pipe connectors monitors differences of at least one of the data of the plurality of data between each of the two subsequent intelligent pipe connectors of the plurality of intelligent pipe connector along the pipeline. Furthermore, the system may include a central control unit having a control server to communicate with the plurality of intelligent pipe connectors. The control server receives the plurality of data and act accordingly on the real time basis based on the differences of the at least one data of the plurality of data along the pipeline.

In one aspect, an intelligent pipe connector is provided for coupling the pipes. The intelligent pipe connector includes a cylindrical ring having an outer and inner ring surfaces opposite to each other. The inner ring surface defines a passageway for the fluid to pass through the cylindrical ring. Further, the intelligent pipe connector may include at least one monitoring and communicating member embedded in the cylindrical ring to monitors the pipeline on a real time basis. Moreover, the intelligent pipe connector may further include a pair of connecting attachments. Each of the connecting attachments may be couple to the cylindrical ring to attach the two subsequent pipes of the plurality of pipes.

In one aspect, a method for monitoring a pipeline supplying fluid from one part of location to another part of location is provided. The method includes, step one, coupling a plurality of pipes to form the pipeline via a plurality of intelligent pipe connectors, wherein each of the intelligent pipe connector of the plurality of intelligent pipe connectors connects at least one end portions of two subsequent pipes of the plurality of pipes; step two, monitoring a plurality of data along the pipeline via the plurality of intelligent pipe connector, wherein the monitoring the plurality of the data comprises monitoring differences of at least one of the data of the plurality of data between each of the two subsequent intelligent pipe connectors of the plurality of intelligent pipe connectors along the pipeline; and, step three, communicating with a central control server via the plurality of intelligent pipe connectors, the control server receives the plurality of data and act accordingly on the real time basis based on the differences of the at least one data of the plurality of data along the pipeline.

These together with the other aspects of the present disclosure, along with the various features of novelty that characterize the present disclosure, are pointed out with particularity in the present disclosure. For a better understanding of the present disclosure, its operating advantages, and its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will be better understood with reference to the following detailed description and claims taken in conjunction with the accompanying drawing, wherein like elements are identified with like symbols, and in which:

FIG. 1 illustrates block diagram of a pipeline leakage protection vault system, in accordance with an exemplary embodiment of the present disclosure;

FIGS. 2A to 2D illustrate leakage protection vault that may be configurable on pipelines, in accordance with an exemplary embodiment of the present disclosure;

FIGS. 3A and 3B, respectively, illustrate assembled and exploded view of a protective casing in a leakage protection vault, in accordance with an exemplary embodiment of the present disclosure;

FIG. 4 illustrates an example diagram electronic circuitry and sensor/nanosensors arrangements over the flexible composite layer, in accordance with an exemplary embodiment of the present disclosure;

FIG. 5 illustrates perspective view of the various modules configured over the pipeline and applicability of photonics boxes in making the pipeline failsafe and leakage proof, in accordance with an exemplary embodiment of the present disclosure;

FIGS. 6A-B, respectively, illustrates example perspective and cut front views of an intelligent pipe connector, in accordance with an exemplary embodiment of the present disclosure;

FIGS. 7A and 7B illustrates example views of monitoring members, in accordance with an example embodiment of the present disclosure; and

FIG. 8 illustrates a system wherein intelligent pipe connectors couples pipes forming the pipeline, in accordance with an example embodiment of the present disclosure.

Like reference numerals refer to like parts throughout the description of several views of the drawings.

### DETAILED DESCRIPTION OF THE PRESENT DISCLOSURE

For a thorough understanding of the present disclosure, reference is to be made to the following detailed description, including the appended claims, in connection with the above described drawings. In the following description, for purposes of explanation, numerous specific details are set forth in order to provide a thorough understanding of the present disclosure. It will be apparent, however, to one skilled in the art that the present disclosure can be practiced without these specific details. In other instances, structures and devices are shown in block diagrams form only, in order to avoid obscuring the disclosure. Reference in this specification to “one embodiment,” “an embodiment,” “another embodiment,” “various embodiments,” means that a particular feature, structure, or characteristic described in connection with the embodiment is included in at least one embodiment of the present disclosure. The appearance of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but may not be of other embodiment's requirement.

Although the following description contains many specifics for the purposes of illustration, anyone skilled in the art will appreciate that many variations and/or alterations to these details are within the scope of the present disclosure. Similarly, although many of the features of the present disclosure are described in terms of each other, or in conjunction with each other, one skilled in the art will appreciate that many of these features can be provided independently of other features. Accordingly, this description of the present disclosure is set forth without any loss of generality to, and without imposing limitations upon, the present disclosure. Further, the relative terms, such as “first,” “second,” “top,” “bottom,” and the like, herein do not denote any order, elevation or importance, but rather are used to distinguish one element from another. Further, the terms “a” and “an” herein do not denote a limitation of quantity, but rather denote the presence of at least one of the referenced item.

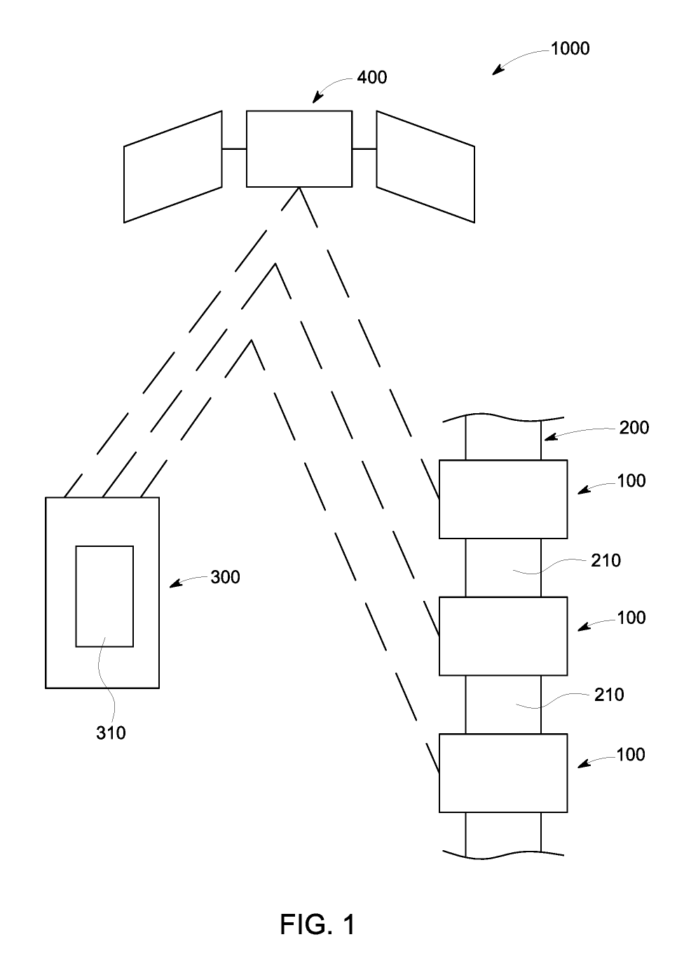

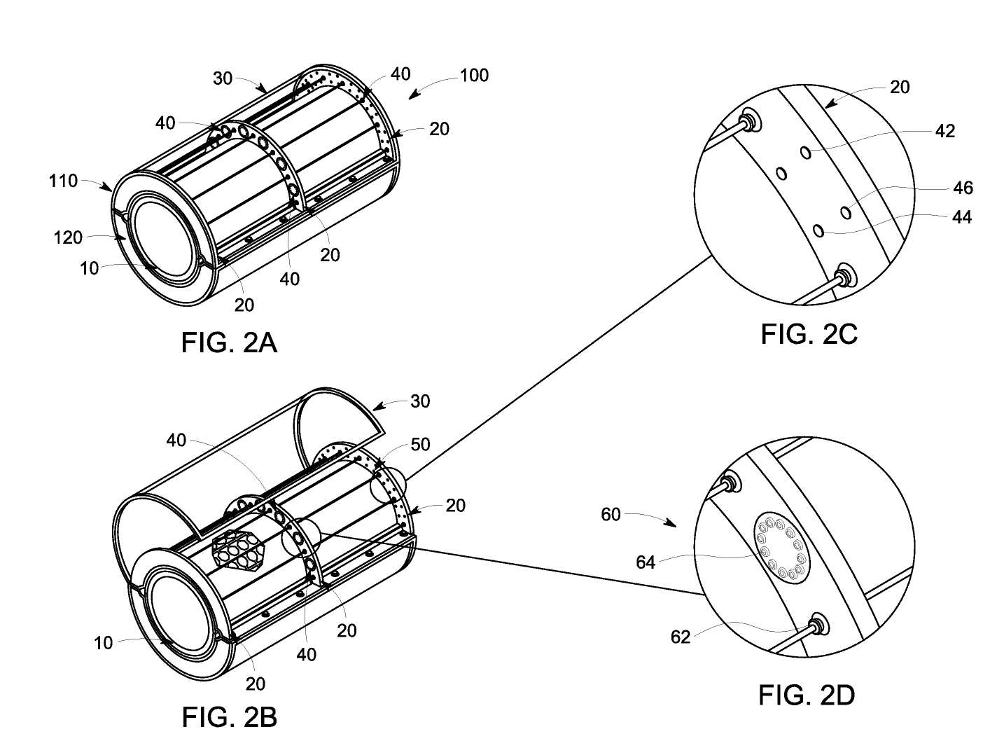

Referring now to FIG. 1, an example block diagram of a pipeline leakage protection vault system 1000 (hereinafter referred to as ‘system 1000’) is illustrated. The system 1000 includes a plurality of leakage protection vault modules 100 (hereinafter referred to as “module(s) 100”) disposed at various locations along a pipeline 200, and is capable of communicating with a central control unit 300 (hereinafter referred to as “control unit 300”) via a Global Positioning System (GPS) 400. Detailed explanation thereof will be made herein later with reference to FIGS. 2A to 4. As shown in FIG. 1, various modules 100 may be disposed over the pipeline 200. In one embodiment, the modules 100 are adapted to be circumferentially disposed, in spaced or closed relation to each other, to various portions of the pipeline 200 and are capable of communicably configured to each other to generate a plurality of real time data related to the pipeline 200 and communicate it to the control unit 300 via the GPS 400. The real time data related to the pipeline 200 may include pipeline leakage data, predict future leakage or failure data, and detect any attempt to theft or tempering related data therein. Further, the control unit 300, which is adapted to communicably configured with the modules 100 receives relevant real time data related to the pipeline 200 and generate a plurality of related information of the pipeline 200 that enables to determine the control authorities any potential leakage, or future leakage that may occur or if there is any attempt of theft or tempering in the pipeline 200, and according enables the concern authorities to act.

Referring now to FIGS. 2A to 2D, which illustrate the module 100 that may be configurable on the pipeline 200, in accordance with an exemplary embodiment of the present disclosure. Specifically, FIGS. 2A and 2B illustrate perspective views of the module 100, and FIGS. 2C and 2D enlarged views of various portions of the module 100.

The module 100 includes a retrofittable configuration which is adapted to include at least two sub-modules 110, 120, which can to be coupled to each other to be snugly disposed circumferentially around various portions of the pipeline 200. The sub-modules 110, 120 are coupled to each other via suitable attachments, for example, screws or nut-bolts attachments 112. In another example, the sub-modules 110, 120 may be pivotally coupled to each other via a suitable pivot attachment. For configuring the module 100 on the pipeline 200, the two sub-modules 110, 120 may be uncoupled from each other and subsequently disposed on the portion of the pipeline 200 where it is required to be disposed, and then couple using the suitable attachments. Where the two sub-modules 110, 120 are attached to each other via the pivot attachment, it is required to opened along pivot and secured around the pipeline 200, and subsequently coupled the other side via suitable attachment like nut-bolts or screws.

Each sub-module 110, 120, as shown in FIG. 2B, includes at least one protective casing 10, spacer rings 20 and a vault door 30. The protective casing 10 is adapted to compliment the portion of the pipeline 200 to be fitted thereon to protect the fluid in event of leakage of the pipeline 200. Further, the spacer rings 20 are adapted to be disposed circumferentially over the protective casing 10 in spaced relationship from each other. The spacer rings 20 includes a plurality of components 40 adapted to monitor a plurality of parameters associated with the pipeline 200 and capable of generating the plurality of real time data related to the pipeline 200. Furthermore, the vault door 30 disposed over the protective casing 10 and rest over the spacer rings 20 covering the respective sub-modules 110, 120. The vault door 30 is capable of withholding the fluid in case of leakage of the pipeline 200 thereby blocking the escaping of the fluid in environment.

In one embodiment, the vault door 30 is adapted to be communicably configured to one or the plurality of components 40 to receive signals therefrom in event of detection in leakage of the pipeline 200. Upon receiving such signals of leakage in the pipeline 200, the vault door 30 may be actuated to tighten the entire module 100 to withhold the fluid therewithin thereby preventing leakage of the fluid to environment. In simplified the vault module 100 makes the present system 1000 an inbuilt disaster recovery system, which may be capable of withholding the fluid in event of leakage in the pipeline 200 due to external or internal condition or threats thereof.

In one embodiment, the vault module 100 may be automatically activated by the plurality of components 40, when one or combinations of the components 40 senses any leakage across the pipeline 200 and enables the actuation of the vault door 30 to be ready to withhold the leaking oil on the real time basis. In an exemplary embodiment, an automated signal from at least one of the component 40 may be send to the vault door 30, which locks the entire module 100 where the breach has taken place. This ensures the leak is contained within the vault module 100 and all servicing partners are notified immediately with video or audio signal information and an automatically compiled disaster recovery report including functional, operational and financial impact of the breach and sent to the control unit 300.

In one embodiment, the at least one of the plurality of components 40 may be nanosensors along with electronic circuitry and microchips to monitor leakage in the pipeline 200 and send signals to vault door 30 to be actuated to cover the module 100 and withhold the oil therewithin. Such vault module 100, in one further embodiment, may be designed as Mission Critical Applications-Disaster Recovery (MCA-DR) architecture, and may have critical component design of Zero Failure component design which utilizes algorithm framework as of the Tandem Nonstop (Never Fail) computer. In yet another embodiment, the at least one of the plurality of components 40 may be disposed on the spacer rings 20 is at least one oil leakage sensor/nanosensor 42 to monitor/sense the parameters related to leakage or security breach in the pipeline 200 and subsequently communicate the real time data of leakage or security breach in the pipeline 200 with the control unit 300. Such sensor/nanosensor 42 may also monitor leakage in the pipeline 200 and send signals to vault door 30 to be actuated to cover the module 100 and withhold the oil therewithin in addition to communicating with the control unit 300.

The control unit 300 via a GPS sensor/nanosensor 50, which in one embodiment may be disposed are disposed on the spacer ring 20, coordinate with the GPS 400 to enable the communication between the modules 100 and the control unit 300.

In one embodiment, at least one of the plurality of components 40 disposed on the spacer rings 20 may be an alarming cloak jet and sensors/nanosensors arrangement 60. The arrangement 60 includes sensors/nanosensors 62 and an alarming clock jet 64. The sensors/nanosensors 62 are arranged across the spacer rings 20 to sense the parameters related to leakage or security breach in the pipeline 200 and generate the real time data of leakage or security breach thereof. Further, the alarming clock jet 64 is disposed on the spacer ring 20 and configured to release dense smoke alarming signal coupled with at least one of high pitch audio alarm and visual lights signal, directly upon being sensed by the sensors/nanosensors 62 or upon the instruction of the control unit 300 in event of the leakage or security breach of the pipeline 200 based on the real time data of leakage or security breach of the pipeline 200 sent to the control unit 300 by the sensors/nanosensors 62.

In one embodiment, at least one of the plurality of components 40 disposed on the spacer rings 20 is at least one temperature sensor/nanosensor 44 to detect the real time data relating to thermal parameters of with the pipelines 200 to communicate to the control unit 300.

In one embodiment, at least one of the plurality of components 40 disposed on the spacer rings 20 is at least one visual recording device 46 to record video information of the various parameter related to the pipeline 200 about the leakage or security breach and communicate the real time date of the pipeline 200 to the control unit 300.

As mentioned above about the protective casing 10, in one embodiment, the protective casing 10 may be single layered structure. In another embodiment, the protective casing 10 may be multilayered structure with or without an additional layer, such as a flexible composite layer 150 (described below) that is capable of facilitating the process of parameter collection, processing and sending it to control unit 300, along by itself or in-combination with the plurality of components 40, 42, 44, 46, 60 configured on the spacer ring 20. Such additional layer may be capable of communicating with various modules 100, various components 40, 42, 44, 46, 60 that are configured on the spacer ring 20, and to the control unit 300, individually, or in in-combination with the various components 40, 42, 44, 46, 60 are configured on the spacer ring 20.

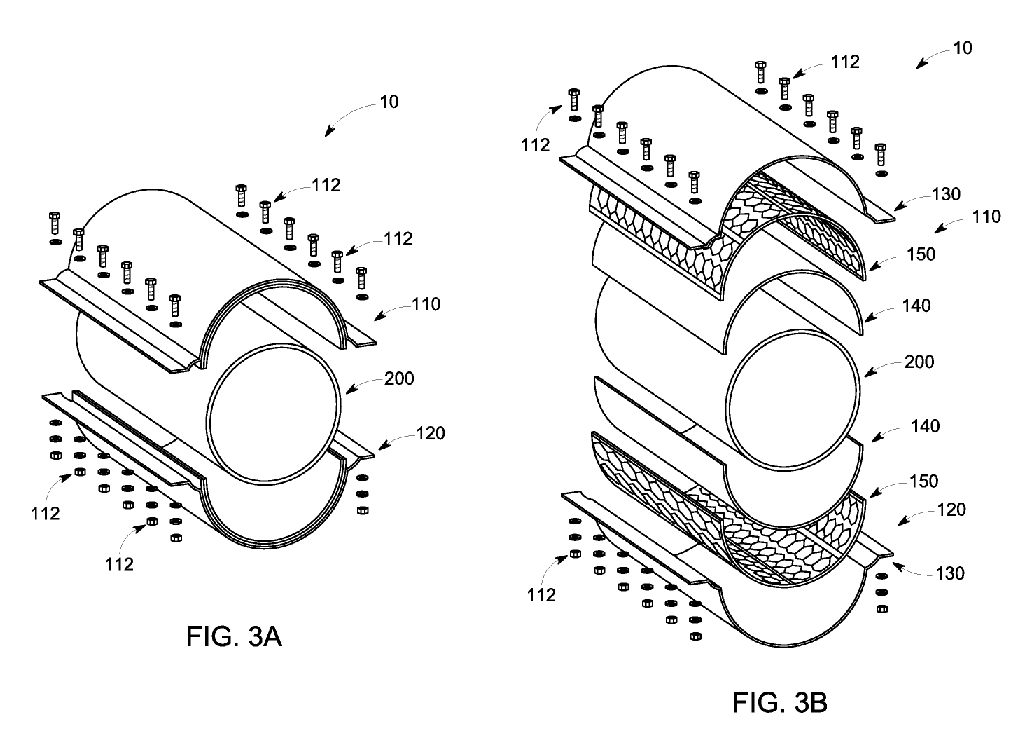

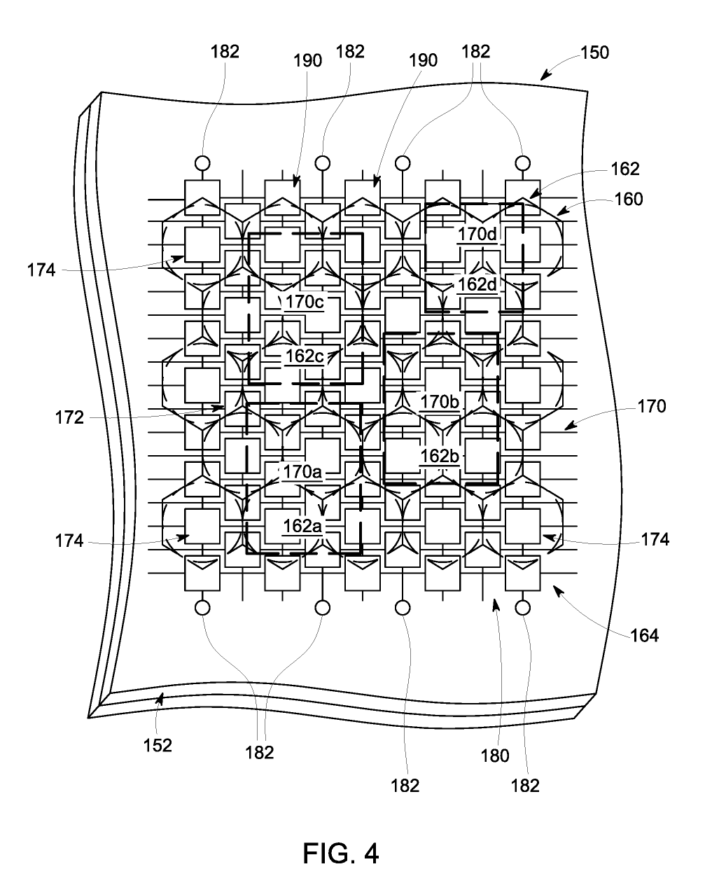

Referring now to FIGS. 3A and 3B to describe the protective covering 10, as per one most preferred embodiment. The protective casing 10 includes top and bottom protective casings 130, 140 and an addition layer of at least one flexible composite layer 150 disposed between the top and bottom protective casings 130, 140 (shown and explained in reference to FIG. 4). Further, each of the sub-module 110, 120 includes at least one layer of electronic circuitry 160 embedded on the flexible composite layer 150. The electronic circuitry 160 comprising a plurality of microchips 162 embedded on each layer of the electronic circuitry 160. Furthermore, a plurality of nanosensors 170 (hereinafter referred to as nanosensors or nanosensor 170 as and when required and shown and explained in reference to FIGS. 3A and 3B) is embedded on the flexible composite layer 150 in coupling relationship with the electronic circuitry 160 and microchips 162. A combinational arrangement of the nanosensor 170, the electronic circuitry 160 and the microchips 162 on the flexible composite layer 150 is capable of monitoring a plurality of parameters associated with the pipeline 200 and generate various real time data, such as mentioned above. Example of the parameter associated with the pipeline 200 may include all the relevant parameters that are capable of determining any leakage, future leakage or any attempt of theft in the pipeline 200, such as, corrosion in the pipeline 200, strain created by internal expending force of fluid in the pipeline 200, condition of peripheral interface of the pipelines 200, changes in temperature, pressure, humidity, shocks, vibrations, and toxic gases along with the position along the pipeline 200, etc.

Alternatively or in another embodiment, arrangement of the nanosensor 170, the electronic circuitry 160 and the microchips 162 on the flexible composite layer 150 is capable of communicably configured with the vault door 30 to send signal to the vault door 30 in event of detection in leakage of the pipeline 200 and actuated thereto to withhold the fluid therewithin, independently or in-combination with the plurality of components 40.

In additional embodiment of the present disclosure, a dielectric layer 152 may be coated over the flexible composite layer 150 to protect the flexible composite layer 150 and the combinational arrangement of the nanosensor 170, the electronic circuitry 160 and microchips 162.

The top and bottom protective casings 130, 140 accommodate the flexible composite layer 150 therewithin in very secure and protective manner from any outside unwanted source, thereby making the module 100 full-proof. In FIGS. 3A and 3B, the arrangement of the sub-modules 110, 120 are illustrated for understanding purpose and may not be considered to be limiting to that specific arrangement, which can vary as per the customers and industry requirement. For example, each of the sub-modules 110, 120 may include more such protective layers to provide additional protection to the modules 100.

Referring now to FIG. 4, wherein, an example diagram of the combinational arrangement of the nanosensor 170, the electronic circuitry 160 and the microchips 162 over the flexible composite layer 150 is illustrated.

As shown in FIG.4, the flexible composite layer 150 has the combinational arrangement of the electronic circuitry 160, the microchips 162 and the sensor/nanosensors arrangements 170 configured thereon. In example embodiment, the combinational arrangement of the electronic circuitry 160, the microchips 162 and the sensor/nanosensors arrangements 170 are printed over the flexible composite layer 150. In such embodiment, the flexible composite layer 150 may be graphene nanosheet made of the intelligent Polyethylene Terephthalate (PET). The flexible composite layer may as per specific demand be produced in a single piece or in various pieces. For example, in one embodiment, the a typical size of one piece of the flexible composite layer may be of size 9 meters with 8 inches diameter, which is a typical size for one piece of a pipe length. Further, the nanosensors 170, for example, may be smart transistor nanosensors. The nanosensors 170, the electronic circuitry 160 and the microchips 162 are printed over the flexible composite layer 150 with closed coordination while maintaining sensors tolerances, escalation mechanisms forming a crystal lattice structure of a matrix 172 of the combinational arrangement of the electronic circuitry 160, the microchips 162 and the sensor/nanosensors arrangements 170 (term sensor/nanosensor may be interchangeable used and intend to have similar meaning) over the flexible composite layer 150, such as shown in FIG. 4.

The matrix 172 may be formed by printing combinational arrangement of the electronic circuitry 160, the microchips 162 and the nanosensors arrangements 170 in rows and columns pattern. The intersection of these rows and columns creates a sensor cell 174 for sensing desired parameters related to the pipeline 200. The spacing between the rows and columns may vary according to sensor/nanosensors 170 and microchip 162 applications based which parameters related to the pipeline 200 required to be sensed and measured. For example, an array of force sensitive cells or pressure sensors along with the respective software coded microchip enables to sense and measure the pressure distribution in the pipeline 200 at the specific location.

In one embodiment, the printing material comprised of a mixture of conductive inks including silver, copper, gold and graphene composite. Further, in one preferred embodiment, the flexible composite layer 150 may also be electrically conductive, to which, when voltage is applied, in association with the matrix 172 obtained by the combinational arrangement of the electronic circuitry 160, the microchips 162 and the sensor/nanosensors arrangements 170, mimic the behavior of the pipeline 200, in event of leakage, theft and regular monitoring of various parameters of the pipeline 200. For example, when voltage is applied, sensor cells 174, which may be octagonal sensor cells 174 slip in and out the crystal lattice structure, which acts as synapse channel between two interfaces of the octagonal sensor cells 174. Due to that, the varying concentration of ions raises or lowers its conductance that transforms into ability to carry information about relevant parameters via the microchips 162 which incorporates respective software. This arrangement of the flexible composite layer 150, the electronic circuitry 160, the microchip 162 and the sensors 170 continuously monitors the changes in the pipeline 200, which provided real time data to the central unit 300.

The matrix 172 obtained by the combinational arrangement of the electronic circuitry 160, the microchips 162 and the sensor arrangements 170 over the flexible composite layer 150 may monitors various parameters related to the pipeline leakage, predict future leakage or failure, and detect any attempt to theft or tempering in the pipeline 200, generating real time data to send it to the control unit 300, which generate various information that help in making prediction of future failure of the pipeline 200 and also information related to present leakage and theft attempt and generate alter to concern authorities. The parameter that may be monitored include, but not limiting to, corrosion in the pipeline 200, strain created by internal expending force of fluid in the pipeline 200, condition of peripheral interface of the pipeline 200, changes in temperature, pressure, humidity, shocks, vibrations, and toxic gases along with the position along the pipeline 200, etc.

In one embodiment, the matrix 172 of the combinational arrangement of the nanosensor 170, the electronic circuitry 160 and microchips 162 may be arranged in a manner where at least one set of nanosensors 170a and the microchips 162a are configured to measure at least one real time data relating to pipeline leakage along the pipeline 200. The real time data relating to pipeline leakage may include fluid leakage frequency and amount, and fluid leakage position and the like. Similarly, in the combinational arrangement of the nanosensor 170, the electronic circuitry 160 and microchips 162, at least another one set of nanosensors 170b and the microchips 162b are may be configured to measure at least one real time data relating to pipeline security breach along the pipeline 200. The real time data relating security breach including, but not limited to, tempering, damage or rupture of the pipeline 200 and position thereof.

In both the above scenarios, the system 1000, in such embodiments, may include a shutdown-valve (not shown) coupled to the pipeline 200, which may be actuated via the nanosensors 170a, 170b and the microchips 162a, 162b in event of the leakage or tempering, damage or rupture of the pipeline 200.

Similarly to above, the matrix 172 of the combinational arrangement of the nanosensor 170, the electronic circuitry 160 and microchips 162 may be arranged in a manner where at least one another set of nanosensors 170c and the microchips 162c may be configured to measure at least one real time data to regular monitor general parameters of the pipeline 200 and predict future leakage to enable preventive maintenance of the pipeline 200 at that location. The real time data relating to estimated future leakage and regular monitoring of the pipeline 200 may include, but not limiting to, corrosion in the pipeline, strain created by internal expending force of fluid in the pipeline 200, condition of peripheral interface of the pipeline 200, changes in temperature, pressure, humidity, shocks, vibrations, toxic gases along with the position along the pipeline 200, and the like.

Further, as shown in FIG. 4, and explained in conjunction with FIG. 1, the matrix 172 of the combinational arrangement of the nanosensor 170, the electronic circuitry 160 and microchips 162 may include at least some of the sensors, such as sensors 170d, to be position sensors. Such position sensors 170d in coordination with the electronic circuitry 160 may be capable of coordinating with all set of sensors 170a-170c and the microchips 162a-162c and send relevant data and position along the pipeline 200 to the control unit 300. In one embodiment, such position sensors 170d may be GPS (Global Positioning System) which is adapted to coordinate with the GPS satellite 400 to enable the communication between the various modules 100 and the control unit 300.

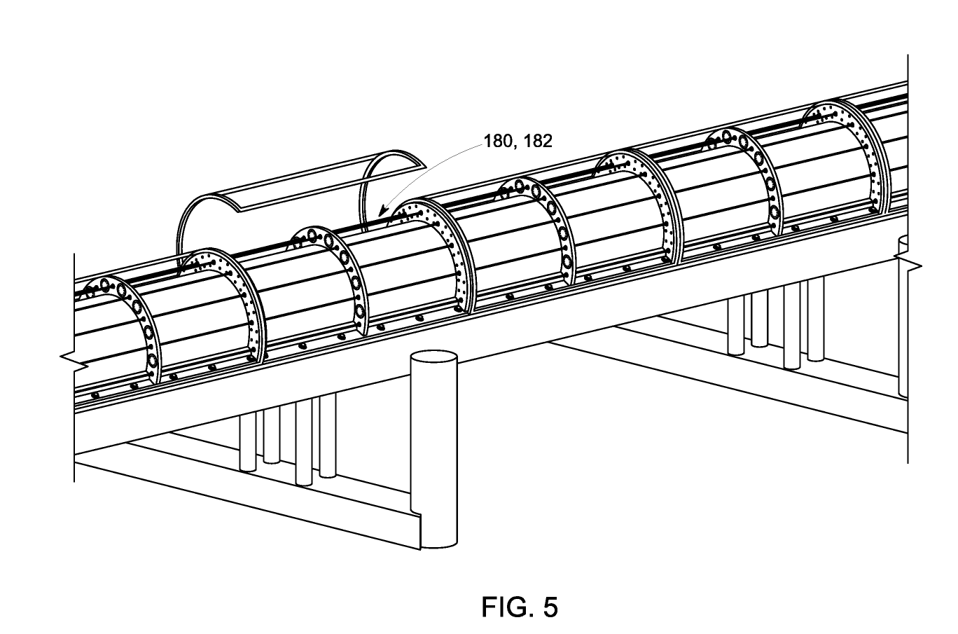

Referring now to FIG. 5, in one further preferred embodiment, the system 1000 may include at least one failsafe layer 180 configured on the flexible composite layer 150. The fail safe layer 180 may include a plurality of photonics boxes 182 on the flexible composite layer 150 in coordination with the combinational arrangement of the nanosensors 170, the electronic circuitry 160 and microchips 162. The photonics boxes 180 may be actuated via voltage to generate information signals in event of leakage, security breach, breakage and monitor of the pipeline 200 on real time basis, thereby making failsafe pipeline. The photonics boxes 180 in the fail safe layer 180, includes a transmitting and receiving devices disposed at distal ends of the module 100, which are capable of transmitting and receiving laser lights through a fiber optics cable between the two adjacent modules 100. In the event of any breach in the pipeline 200, the photonics boxes 180 are in coordination with the nanosensors 170, the electronic circuitry 160 and the microchips 162, generates information signals until the primary system is restored. The failsafe layer 180 with the photonic boxes 182 may be capable of generating a single line or several lines with multi layers disposed on the flexible composite layer 150.

Further, in one additional embodiment, there may be at least one failsafe mechanism configured on the spacer ring 20. The fail safe mechanism may include a plurality of photonics boxes, such as boxes 182, which independently or in coordination with the combinational arrangement of the nanosensor 170, the electronic circuitry 160 and the microchips 162, are actuated via voltage to generate information signals in event of leakage, security breach, breakage and monitor of the pipeline 200 on real time basis.

In one further preferred embodiment, the system 1000 may further include a layer of photovoltaic arrangement 190 disposed on the flexible composite layer 150 in coordination with the combinational arrangement of the nanosensor 170, the electronic circuitry 160 and the microchips 162 to generate required voltage for the operation of the photonics boxes 182 and the flexible composite layer 150 as described above.

Further, in one additional embodiment, there may be a photovoltaic arrangement configured on the spacer ring 20, which in coordination with the combinational arrangement of the nanosensor 170, the electronic circuitry 160 and the microchips 162 to generate required voltage for the operation of the photonics boxes 182 and the flexible composite layer 150.

In one further preferred embodiment, the system 1000 may further include a provision of alarming signal in event of any default. Specifically, in the combinational arrangement of the nanosensor 170, the electronic circuitry 160 and microchips 162; at least one microchip 162 may be an alarming microchip 164 with integrated software, which in combination of the nanosensor 170 and the electronic circuitry 160 is adapted to generate alarming signal, in event of leakage or security breach of the pipeline 200. The signal may be audio, smoke or visual lights.

In any event of failure or leakage of the pipeline 200, the system 1000 with the help of modules 100, specifically, the combinational arrangement of the nanosensor 170, the electronic circuitry 160 and microchips 162, is capable of generating real time data at the site of conflicts of the pipeline 200 and sends only relevant data to the control unit 300 via the GPS 400, in turn reducing the processing load on the control unit 300. Alternatively, the modules 100 or specifically, the combinational arrangements of the nanosensor 170, the electronic circuitry 160 and microchips 162 of the modules 100, are capable of generating real time data at the site of conflicts of the pipeline 200 and send all data to the control unit 300 via GPS 400, if required.

All the elements, such as the various sets of sensors 170, 170a-170d and microchips 162, 162a-162d, the fail safe layer 180 and the photonic boxes 182, and the photovoltaic arrangement 190 may independently or in coordination with the plurality of components 40, 42, 44, 46, 60 configured on the spacer ring 20 work to generate information signals in event of leakage, security breach, breakage and monitor of the pipeline 200 on real time basis.

The system of the present disclosure is advantageous in various scopes. The system preclude conventional technique of generation limited information related to pipelines and provides integrated pipeline monitoring and protection system, which is capable of offering real time monitoring and protection of the entire pipeline regarding leakage, theft or predict even future leakage and enables to take preventive measures to avoid such leakage. Further, the vault module of the present disclosure may installed along the entire pipeline to enable pipeline integrity in terms of protection of the entire pipeline as against the available prior-art technologies which are largely based on the protection or presentation of specific regions of the pipeline.

Further, until now, as per the known availability of the conventional prior art technologies, the vault module of the present invention may be first of its kind product, which is inbuilt disaster recovery device and provides substantially cent percent protection against leakage of the fluid from the pipeline to fall to the near surrounding or environment. Additionally, apart from having advantage of being inbuilt disaster recovery device, it also includes several additional multilayer protection for complete protection from infrastructure failure especially oil containment when pipes just fail, as described above. In that sense, the module of the present disclosure may is capable of monitoring, if required, all the relevant parameters of the pipelines in a cost effective manner as against the available prior-art technologies where specific tools or method are incorporated on the pipeline which are only required in that region of the pipeline because of huge costing involved in installing all the tools and method at each locations of the pipelines.

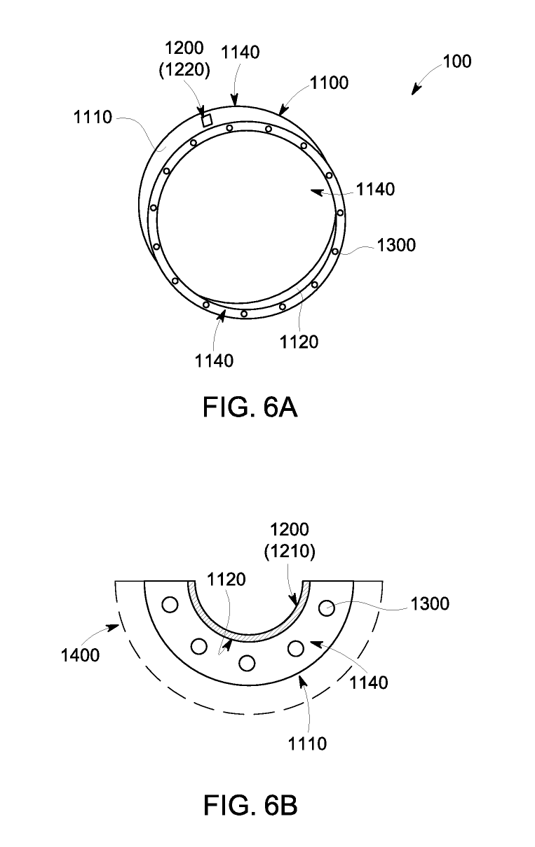

Reference to FIGS. 6A-B, 7A-7B and 8 will now be made in order to describe further embodiments of the present disclosure, and reference of other figures, such as FIGS. 1 to 5, may be made as and when required for understanding the embodiments of the present invention. Further, while describing FIGS. 6A-B, 7A-7B and 8, certain reference numerals are duplicated for referring to elements of the present embodiments as described in FIGS. 6A-B, 7A-7B and 8.

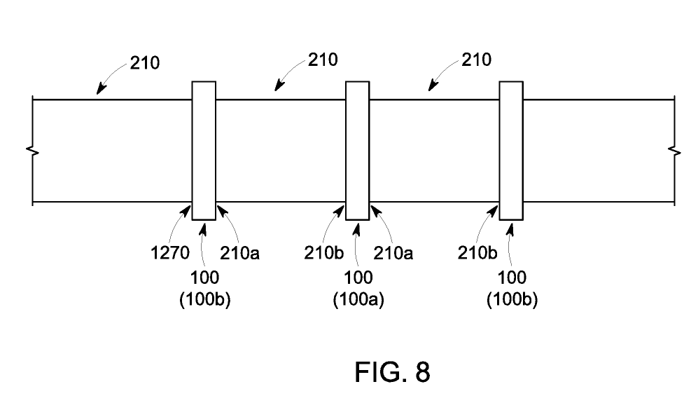

Referring now to FIG. 1, an example of an intelligent pipe connector 100 is illustrated, in accordance with an exemplary embodiment of the present disclosure. Such intelligent pipe connector 100 may be coupled in a pipeline 200 between the two adjacent pipes 210 to configure an in pipeline, such as pipeline 200, to supply fluid, such as oil, water, gas, from one part of location to another part of location. Such example arrangement is illustrated in FIG. 8. The intelligent pipeline 200 configured to comminute with a central control unit 300 with the help of the intelligent pipe connects 100 forming an intelligent pipeline system 1000 to monitor the pipeline on the real time basis.

In as much as the construction and arrangement of the pipeline system or pipe connects as depicted in FIGS. 6A-B, 7A-B and FIG. 8 along with said other components may be well described above with reference to FIGS. 1 to 5 submitted as original text in parent application Ser. No. 14/546,328, and it is not deemed necessary for purposes of acquiring an understanding of the present disclosure that there be recited herein all of the constructional details and explanation thereof again. Rather, it is deemed sufficient to simply take the reference of the suitable paragraph of from above to acquitting an understanding of related technical details. Further, it should be understood that the pipeline system or pipe connects may include a variety of components for performing their assigned purpose, and only those components are shown and described herein that are relevant for the description of various embodiments of the present disclosure.

Referring now to FIGS. 6A and 6B, the intelligent pipe connector 100 and its various embodiments are illustrated. In one embodiment, as shown in FIG. 6, the intelligent pipe connector 100 includes a cylindrical ring 1100, at least one monitoring and communicating member 1200, and a pair of connecting attachments 1300. In an example, the cylindrical ring 1100 may include an outer 1110 and inner 1120 ring surfaces opposite to each other. The inner ring surface 1120 may define a passageway 1130 for the fluid to pass through the cylindrical ring 1100. Further, the cylindrical ring 1100 defines opposite peripheries 1140 extending between the outer 1110 and inner 1120 ring surfaces.

The pair of connecting attachments 1300 may be coupled to the cylindrical ring 1100. Each of the connecting attachments 1300 coupled to the cylindrical ring 1100 to attach the two subsequent pipes of the plurality of pipes, as seen in FIG. 8. In one embodiment, each of the connecting attachments 1300 may be coupled along each respective periphery 1140 of the opposite peripheries 1140 of the cylindrical ring 1100 to attach the two subsequent pipes 210 of the plurality of pipes 210 along the opposite peripheries 1140 of the cylindrical ring 1100. The cylindrical ring 1100 through the connecting attachments 1300 may snugly attach end portions of the two adjacent pipes 210 to provide leakage proof connection between the pipes 210. Examples of the connecting attachments 1300 may include, but not limited to, a nut and bolt assembly, a suitable flange configuration and assembly, a snapped coupling assembly, a male-female structured assembly and the like. However, without departing from the scope of the present disclosure, the connecting attachment 1300 may include any other connecting assembly that is capable of snugly coupling the pipes ends that provides leakage proof assembly between the two adjacent pipes.

Further, the at least one monitoring and communicating member 1200 may be embedded in the cylindrical ring 1100 to monitors the pipeline 200 on a real time basis. In one embodiment, as shown in FIG. 6A, the monitoring and communicating member 1200 may include a monitoring member 1210, and a communicating member 1220 communicably coupled to the monitoring member 1210. The monitoring member 1210 may, in one embodiment, includes an inbuilt monitoring module that is incorporated in the cylindrical ring 100. In one embodiment, the monitoring member 1210 may be provided in on the inner ring surface 1120 of the cylindrical ring 100. In an example, monitoring module or sensors associated therewith may be inserted into the ring from a horizontal or vertical angle with respect to the cylindrical ring 1100. The vertical insertion may allow easy replacement of monitoring module or sensors without shutdown of the cylindrical ring 1100. In one embodiment, an inbuilt monitoring module may include a flexible composite layer, and a combinational arrangement of nanosensors, the electronic circuitry and microchips disposed the flexible member on to monitor the pipeline on the real time basis, such as, shown in FIG. 4, the flexible composite layer 150 having the combinational arrangement of the electronic circuitry 160, the microchips 162 and the sensor/nanosensors arrangements 170 configured thereon and as described in parent application Ser. No. 14/546,328, and reproduced herein above. The monitoring member 1210 monitors various parameters related to the pipeline through the arrangement, such as those described in parent application Ser. No. 14/546,328 and reproduced herein above. Further, the communicating member 1220, which is communicably coupled to the monitoring member 1210 and the central control unit 300 receives the plurality of data of the pipeline 200 from the monitoring member 1210 and send to the central control server 310. The communicating member 1220 may be all the communication members as the members such as those described in parent application Ser. No. 14/546,328, and reproduced herein above and excluded herein for the sake of brevity.

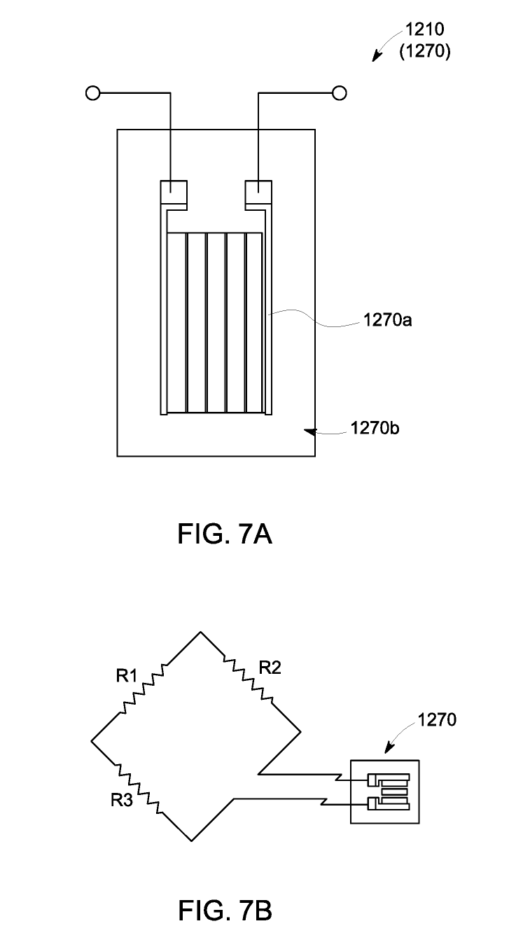

In another embodiment, as seen in FIGS. 7A and 7B, the monitoring member 1210 may include an inbuilt monitoring module that is incorporated in the cylindrical ring 100, wherein such inbuilt monitoring module may be a gauge sensor arrangement 1270 to monitor the pipeline on the real time basis. In one embodiment, the gauge sensor arrangement 1270 may be disposed on the inner ring surface 1120 of the cylindrical ring 100. The gauge sensor arrangement 1270 may include fundamental sensing elements for various types of sensors, including, but not limited to, pressure sensors, load sensors, torque sensors, position sensors and the like.

The gauge sensor arrangement 1270, in one example embodiment, may be made of a strip of conductive metallic layer 1270a (metallic strip 1270a) deposited on a non-conducting flexible substrate 1270b. The metallic strip 1270a may reflect a pattern of resistivity which operates on the principle of that as the metallic strip 1270a is subject to stress, the resistance of the metallic film changes in a defined way. Such change in resistivity may be used to measure the change in pipeline parameters, such as pressure, load, torque, flow of liquid, amount of flow of liquid, etc., between the two intelligent pipe connectors 100.

In one example embodiment, as shown in FIG. 7B, the resistivity may be measured using bridge measurement circuit. As shown, a rheostat arm of the bridge (R2 in the diagram) is set at a value equal to the strain gauge resistance with no force applied. Further, two ratio arms of the bridge (R1 and R3) are set equal to each other. Thus, with no force applied to the strain gauge, the bridge will be symmetrically balanced and the voltmeter will indicate zero volts, representing zero force on the strain gauge. As gauge sensor arrangement 1270 is either compressed or tensed with effect o the fluid in the pipeline 200, its resistance will decrease or increase, respectively, thus unbalancing the bridge and producing an indication to be communicated by the communicating members 1220 to the server 300.

The intelligent pipe connector 100, in one embodiment, may include a vault door 1400 disposed over each of the intelligent pipe connector 100. The vault door 1400 is described in parent application Ser. No. 14/546,328 on which this CIP Application is based, and reproduced herein above as vault door 30. The vault door 1400 withholds the fluid in case of leakage along the joints of the pipeline, thereby blocking the escaping of the fluid in environment.

Referring now to FIG. 8, an intelligent pipeline system 1000 for supplying fluid from one part of location to another part of location is disclosed. The intelligent pipeline system 1000 includes the plurality of pipes 210 coupled to one another via the plurality of intelligent pipe connectors 100 to form the pipeline 200 for supplying the fluid. Each of the intelligent pipe connector 100 of the plurality of intelligent pipe connectors 100 connects at least one end portions 210a, 210b of two subsequent pipes 210 of the plurality of pipes 210 via the connecting attachments 1300 to form the pipeline 200.

Further, the plurality of intelligent pipe connectors 100 may monitor a plurality of data along the pipeline 200 via the monitoring and communicating member 120. The plurality of intelligent pipe connectors 100 through the monitoring and communicating member 1200 may monitor differences of at least one of the data of the plurality of data between each of the two subsequent intelligent pipe connectors 100 of the plurality of intelligent pipe connector 100 along the pipeline 200. Examples of data that may be monitored along the pipeline be leakage detection, theft detection, location of the leakage or theft, corrosion, fatigue or erosion detection, amount of flow detection, pipes' internal wall thickness erosion, and other related physical parameters associated with the pipes and pipelines.

Furthermore, the central control unit 300 may be provided in the system 1000. The central control unit 300 may include a control server 310 to communicate with the plurality of intelligent pipe connectors 100. The control server 310 receives the plurality of data and act accordingly on the real time basis based on the differences of the at least one data of the plurality of data along the pipeline 200.

In operations, with reference of FIG. 8, the plurality of intelligent pipe connectors 100 coupled along the plurality of pipes 210 connects at least one end portions 210a, 210b of two subsequent pipes 210 of the plurality of pipes 210 and monitors differences of at least one of the data of the plurality of data between each of the two subsequent intelligent pipe connectors 100 of the plurality of intelligent pipe connectors 100 along the pipeline 200, and subsequently communicates with the a central control server 300.

For example, the monitoring may be done in two phases. To understand this, referring to FIG. 8, wherein the middle connector may be considered to be a primary connector 100a, and on the both sides of the primary connectors 100a, the side connectors may be considered as secondary connectors 100b. In first phase, monitoring may be done with the inbuilt monitoring module, such as the gauge sensor arrangement 1270 or with the arrangement of the flexible composite layer and the combinational arrangement of nanosensors, the electronic circuitry and microchips, on the intelligent pipe connectors 100. For understanding, the embodiment of the gauge sensor arrangement 1270 may he explained herein. So in the first phase, monitoring of the various data along the pipeline may be done by the primary connectors 100a, herein alter referred to as primary measurement data. Further, monitoring of the various data along the pipeline 200 may be done along the secondary connectors 100b disposed on each sides of the primary connector 100a, hereinafter referred to as secondary measurement data. Primary and secondary measurement data may be based on the variation of resistivity along the gauge sensor arrangement 1270, measured using the circuit as seen in FIG. 7B. For example, when the flow of the fluid in the pipeline along the secondary connectors 100b varies from the flow of the fluid at the primary connectors 100a, there may be resistance variation along the metallic strips 127a of the gauge sensor arrangements 127 due to variation of stress along the metallic strips 127a.

In the second phase, the primary and secondary measurement data may be sent to the control server, analysis may be carried on the primary and secondary measurement data and an output data may be calculated. Bases on the calculated data, the control server, if finds variation between two pipe connectors 100, instructs appropriate action command to an operating center nearby to take up corrective action at the particular location along the pipeline where there is variation of output data. Without departing from the scope of the present disclosure, analysis of the primary and secondary measurement data between the two adjacent connectors may be done at the connectors itself, and instruction may be directly send to the an operating center nearby to take up corrective action at the particular location.

Variation of primary and secondary measurement data may be effective in monitoring leakage detection, location of leakage and flow assurance with the varying effects of amount of fluid flowing between the primary 100a and the secondary 100b connectors. Further, variation of primary and secondary measurement data may he effective in monitoring corrosion or fatigue or erosive point along the pipeline due the effect of variation of pressure, wherein weakest pressure point may signifies corrosive area. Variation in the primary and secondary measurement data may be calculated based on the change in resistivity of the metallic strip 127a of gauge sensor arrangements 127, as described herein.

Moreover, the module or system of the present disclosure may also be capable of generating real time data of the pipeline and at the same time reduce the processing load on a central control unit. Furthermore, one of the most important advantage of the present disclosure is to preclude oil/gas leakage in any case to avoid pollution and wastage of thereof. Various other advantages and features of the present disclosure are apparent from the above detailed description and appendage claims. Additionally, the present invention may include all the advantages, features and component of its parent application and build these features into the intelligent pipe connector as described. The intelligent pipe connector may be a scalable product which can easily be configured for any application i.e. oil pipelines or water. The intelligent pipe connector may be smart, intelligent and autonomous thereby making pipeline intelligent. Further, with such intelligent pipe connectors, the requirement of disposing monitoring devices along the entire pipeline, as in conventional arrangement, may be entirely precluded because, the intelligent pipe connector may be disposed between the two pipes to measure various parameters between two and trigger respective action. It is advantageous that with hundreds of intelligent pipe connector installed across, say 100-mile pipeline, one could accurately detect the condition of the pipeline and the failure points, as each ring is working intelligently and independently of other rings.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. An intelligent pipeline system for supplying fluid from one part of location to another part of location, the intelligent pipeline system, comprising:
a plurality of pipes coupled to one another to form the pipeline for supplying the fluid;
a plurality of intelligent pipe connectors to monitor a plurality of data along the pipeline, each of the intelligent pipe connectors of the plurality of intelligent pipe connectors connects at least one end portions of two subsequent pipes of the plurality of pipes to form the pipeline, wherein the plurality of intelligent pipe connectors monitor differences of at least one of the data of the plurality of data between each of the two subsequent intelligent pipe connectors of the plurality of intelligent pipe connectors along the pipeline; and
a central control unit having a control server to communicate with the plurality of intelligent pipe connectors, the control server receives the plurality of data and act accordingly on a real time basis based on differences of the at least one data of the plurality of data along the pipeline.

2. The intelligent pipeline system as claimed in claim 1, wherein each of the plurality of intelligent pipe connectors comprises:
a cylindrical ring having an outer and inner ring surfaces opposite to each other, the inner ring surface defines a passageway for the fluid to pass through the cylindrical ring;
at least one monitoring and communicating member embedded in the cylindrical ring to monitors the pipeline on a real time basis; and
a pair of connecting attachments, each of the connecting attachments coupled to the cylindrical ring to attach the two subsequent pipes of the plurality of pipes.

3. The intelligent pipeline system as claimed in claim 2, wherein the at least one monitoring and communicating member comprises:
a monitoring member having
a flexible composite layer, and
a combinational arrangement of nanosensors, electronic circuitries and microchips disposed the flexible member on to monitor the pipeline on the real time basis; and
at least one communicating member communicably coupled to the monitoring member and the central control unit to receives the plurality of data of the pipeline from the monitoring member and send to the control server.

4. The intelligent pipeline system as claimed in claim 3, wherein the monitoring member is comprised on the inner ring surface.

5. The intelligent pipeline system as claimed in claim 2, wherein the at least one monitoring and communicating member comprises:
a monitoring member having a strain gauge sensor arrangement to monitor the pipeline on the real time basis; and
at least one communicating member communicably coupled to the monitoring member and the central control unit to receives the plurality of data of the pipeline from the strain gauge monitoring member and send to the control server.

6. The intelligent pipeline system as claimed in claim 5, wherein the monitoring member is comprised on the inner ring surface.

7. The intelligent pipeline system as claimed in claim 1 further comprising a vault door disposed over each of the intelligent pipe connectors of the plurality of intelligent pipe connectors, wherein the vault door withholds the fluid in case of leakage along joints of the pipeline, thereby blocking the escaping of the fluid in environment.

8. A method for monitoring a pipeline supplying fluid from one part of location to another part of location, the method, comprising:
coupling a plurality of pipes to form the pipeline via a plurality of intelligent pipe connectors, wherein each of the intelligent pipe connectors of the plurality of intelligent pipe connectors connects at least one end portions of two subsequent pipes of the plurality of pipes;
monitoring a plurality of data along the pipeline via the plurality of intelligent pipe connectors, wherein the monitoring the plurality of the data comprises monitoring differences of at least one of the data of the plurality of data between each of the two subsequent intelligent pipe connectors of the plurality of intelligent pipe connectors along the pipeline; and
communicating with a central control server via the plurality of intelligent pipe connectors, the control server receives the plurality of data and act accordingly on real time basis based on the differences of the at least one data of the plurality of data along the pipeline.

9. A method as claimed in claim 8, further comprising:
withholding the fluid in case of leakage along the joints of the pipeline thereby blocking the escaping of the fluid in environment.

10. An intelligent pipe connector for connecting pipes in a pipeline supplying fluid, the intelligent pipe connector, comprising:
a cylindrical ring having an outer and inner ring surfaces opposite to each other, the inner ring surface defines a passageway for the fluid to pass through the cylindrical ring;
at least one monitoring and communicating member embedded in the cylindrical ring to monitors the pipeline on a real time basis; and
a pair of connecting attachments, each of the connecting attachments coupled to the cylindrical ring to attach the two subsequent pipes of the plurality of pipes.

11. The intelligent pipe connector as claimed in claim 10, wherein the at least one monitoring and communicating member comprises:
a monitoring member having
a flexible composite layer, and
a combinational arrangement of nanosensors, electronic circuitries and microchips disposed the flexible member on to monitor the pipeline on the real time basis; and,
at least one communicating member communicably coupled to the monitoring member and the central control unit to receives the plurality of data of the pipeline from the monitoring member and send to the control server.

12. The intelligent pipe connector as claimed in claim 11, wherein the monitoring member is comprised on the inner ring surface.

13. The intelligent pipe connector as claimed in claim 10, wherein the at least one monitoring and communicating member comprises:
a monitoring member having a strain gauge sensor arrangement to monitor the pipeline on the real time basis; and
at least one communicating member communicably coupled to the monitoring member and the central control unit to receives the plurality of data of the pipeline from the strain gauge monitoring member and send to the control server.

14. The intelligent pipe connector as claimed in claim 13, wherein the monitoring member is comprised on the inner ring surface.

15. The intelligent pipe connector as claimed in claim 10 further comprising a vault door disposed over the intelligent pipe connector, wherein the vault door withholds the fluid in case of leakage along joints of the pipeline, thereby blocking the escaping of the fluid in environment.
